(19) United States
(12) Patent Application Publication
(10) Pub. No.: US 2025/0222878 A1
(43) Pub. Date: Jul. 10, 2025

(54) MOBILE FRAME FOR VEHICLE

(71) Applicants: Hyundai Motor Company, Seoul (KR); Kia Corporation, Seoul (KR)

(72) Inventor: Seo Rin KIM, Gunpo-si (KR)

(73) Assignees: Hyundai Motor Company, Seoul (KR); Kia Corporation, Seoul (KR)

(21) Appl. No.: 18/966,962

(22) Filed: Dec. 3, 2024

(30) Foreign Application Priority Data
Jan. 5, 2024 (KR) 10-2024-0002216

(51) Int. Cl. B60R 11/02; B60R 11/00

(52) U.S. Cl. CPC B60R 11/0235; B60R 2011/005; B60R 2011/008

(57) ABSTRACT

A mobile frame for a vehicle includes a main body configured so that a convenience device is mounted on or separated from the main body, the main body being coupled to a rail formed on a floor of the vehicle, configured to be slidable on the rail, and configured to be withdrawn to the outside of the vehicle through an opening portion of a door of the vehicle, and moving wheels connected to a lower portion of the main body by link assemblies and configured to be accommodated in the lower portion of the main body, when the main body is coupled to the floor of the vehicle, and deployed downwardly from the main body when the main body is withdrawn to the outside of the vehicle.

### CROSS-REFERENCE TO RELATED APPLICATION

The present application claims priority to Korean Patent Application No. 10-2024-0002216, filed on Jan. 5, 2024, the entire contents of which is incorporated herein for all purposes by this reference.

### BACKGROUND OF THE PRESENT DISCLOSURE

### Field of the Present Disclosure

The present disclosure relates to a mobile frame for a vehicle, which is configured for being installed inside or outside a vehicle and equipped with various convenience devices which may be freely used by users from the inside and the outside of the vehicle.

### Description of Related Art

Autonomous vehicles have been developed beyond simple transportation means to a concept in which a space in the vehicle may be used while the vehicle moves.

Because a driver does not drive the autonomous vehicle, occupants in the interior of the vehicle may perform various activities. To the present end, various convenience devices need to be mounted in the vehicle.

For example, a display with a large screen may be mounted in the vehicle so that the occupant watches movies, makes a video call, or retrieve various information while traveling by the vehicle.

Alternatively, a storage box, a table, or the like may be installed, and an air conditioning device or various mechanisms required in the vehicle may be required to be installed.

However, predetermined mechanisms are installed at predetermined points in a narrow space in the current vehicle, which makes it difficult to cope with various needs of the users.

Therefore, for the autonomous vehicle to meet various requirements of the users, various convenience devices need to be replaceably installed or separated at a particular point in the interior of the vehicle to meet the user's requirements.

Meanwhile, the vehicle expands to a concept of a space which may be used in daily life beyond a simple transportation means. The vehicle may be used as a movable store or hostel after the vehicle is stationary. In the instant case, the convenience devices in the vehicle may be used from the outside of the vehicle.

Therefore, in the future, there is a demand for a system capable of being freely installed inside or outside the vehicle and providing the users with wide ranges of utilization and satisfaction by mounting compatibility with various convenience devices.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a mobile frame for a vehicle, which is configured for being provided inside or outside a vehicle and provided with various convenience devices which may be freely used by users from the inside or outside of the vehicle.

To achieve the above-mentioned object, a mobile frame for a vehicle according to an exemplary embodiment of the present disclosure includes: a main body configured so that a convenience device is mounted on or released from the main body, the main body being coupled to a rail formed on a floor of the vehicle, configured to be slidable on the rail, and configured to be withdrawn to the outside of the vehicle through an opening portion of a door of the vehicle; and moving wheels connected to a lower portion of the main body by link assemblies and configured to be accommodated in the lower portion of the main body, when the main body is coupled to the floor of the vehicle, and deployed downwardly from the main body when the main body is withdrawn to the outside of the vehicle.

The main body may include a quadrangular frame shape.

The convenience device may be at least one of a display, a storage box, a shelf, and a table.

A connector may be provided at a lower end portion of the main body, and the convenience device may be electrically connected to the vehicle through the connector and the rail.

The main body may be supported on the rail by the moving wheel.

The rail may extend in a direction from the floor of the vehicle toward the door.

The rail may include a groove shape recessed in the floor of the vehicle, a catching portion may be formed on an upper portion of the rail, and a protruding portion may be formed at a lower end portion of the main body and caught by the catching portion without being withdrawn upward in a state in which the protruding portion is inserted into the groove of the rail.

When the main body is coupled to the floor of the vehicle, the link assembly may be folded and accommodated in the lower portion of the main body, and a lower end portion of the moving wheel may be exposed downwardly from the main body and supported on the rail.

The link assembly may include a deployment portion configured to provide elasticity in a deployment direction, and when the main body is withdrawn to the outside of the vehicle, the link assembly may be deployed by the deployment portion, and the moving wheel may be supported on a ground surface outside the vehicle.

The link assemblies and the moving wheels may be provided at two opposite sides of a lower end portion of the main body, and when the main body is withdrawn from the vehicle, the link assembly, which is one of the link assemblies at the two opposite sides which is withdrawn first, may be deployed and supported on a ground surface by the moving wheel, and in the instant state, the remaining portion of the main body may be withdrawn.

The mobile frame for a vehicle of the present disclosure may be provided inside or outside the vehicle and provided with various convenience devices which may be freely used by the users inside or outside the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a state in which a mobile frame for a vehicle according to an exemplary embodiment of the present disclosure is provided in a vehicle.

FIG. 2 is a view exemplarily illustrating a state in which the mobile frame for a vehicle according to the exemplary embodiment of the present disclosure is provided outside the vehicle.

FIG. 3 and FIG. 4 are views exemplarily illustrating a state in which a link assembly of the mobile frame for a vehicle according to the exemplary embodiment of the present disclosure is accommodated.

FIG. 5 is a view exemplarily illustrating a state in which the link assembly of the mobile frame for a vehicle according to the exemplary embodiment of the present disclosure is deployed.

FIG. 6 is a view exemplarily illustrating a state in which the mobile frame for a vehicle according to the exemplary embodiment of the present disclosure is provided on a floor of the vehicle.

FIG. 7 is a view exemplarily illustrating a state in which the mobile frame for a vehicle according to the exemplary embodiment of the present disclosure is withdrawn from the vehicle.

FIG. 8 is a view exemplarily illustrating a state in which the link assembly of the mobile frame for a vehicle according to the exemplary embodiment of the present disclosure is deployed outside the vehicle.

FIG. 9 is a view exemplarily illustrating a state in which the link assembly of the mobile frame for a vehicle according to the exemplary embodiment of the present disclosure is accommodated outside the vehicle.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the accompanying drawings. The same or similar constituent elements are assigned with the same reference numerals regardless of reference numerals, and the repetitive description thereof will be omitted.

In the description of the embodiments included in the present specification, the specific descriptions of publicly known related technologies will be omitted when it is determined that the specific descriptions may obscure the subject matter of the embodiments included in the present specification. Furthermore, it should be interpreted that the accompanying drawings are provided only to allow those skilled in the art to easily understand the embodiments included in the present specification, and the technical spirit included in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

The suffixes “module”, “unit”, “part”, and “portion” used to describe constituent elements in the following description are used together or interchangeably to facilitate the description, but the suffixes themselves do not have distinguishable meanings or functions.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

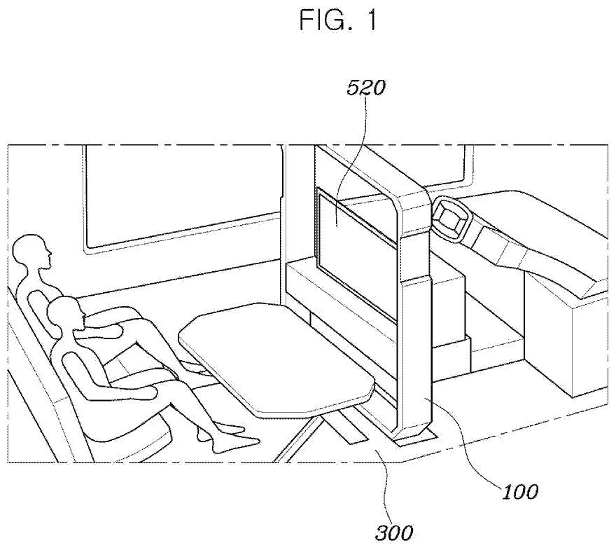

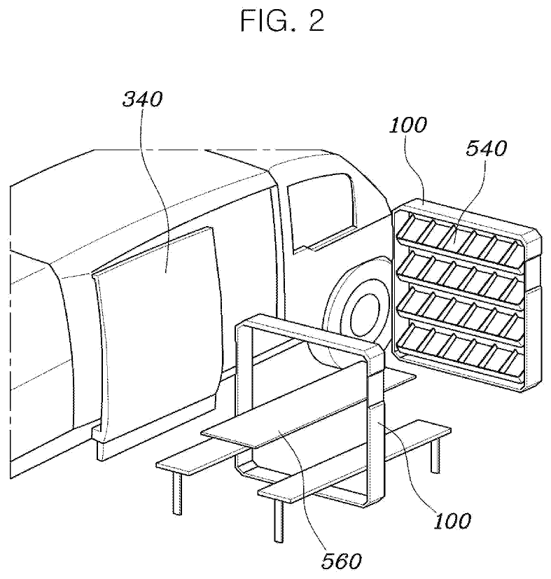

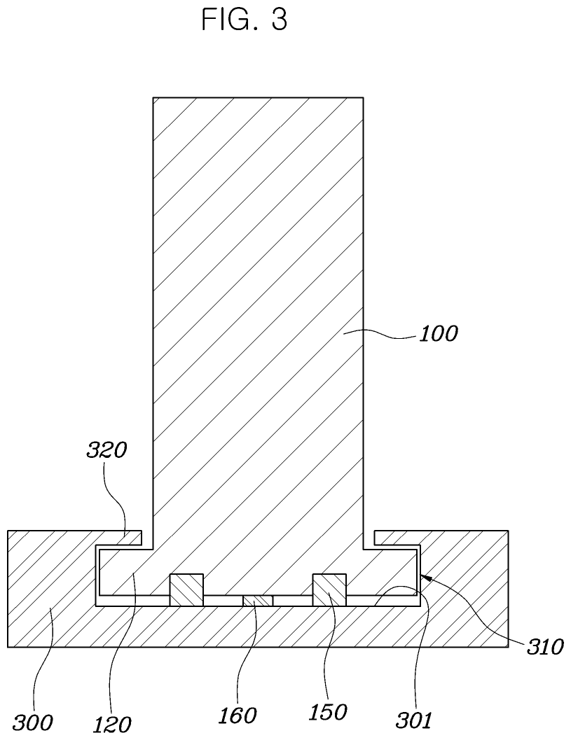

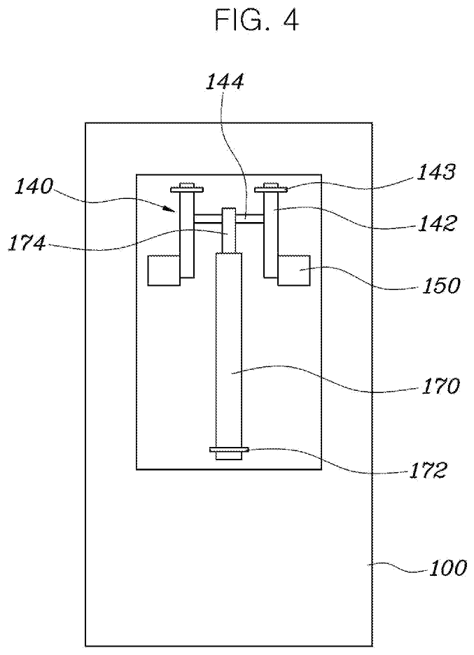

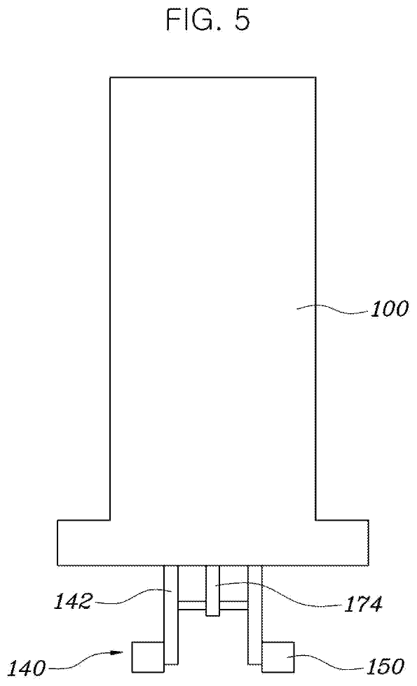

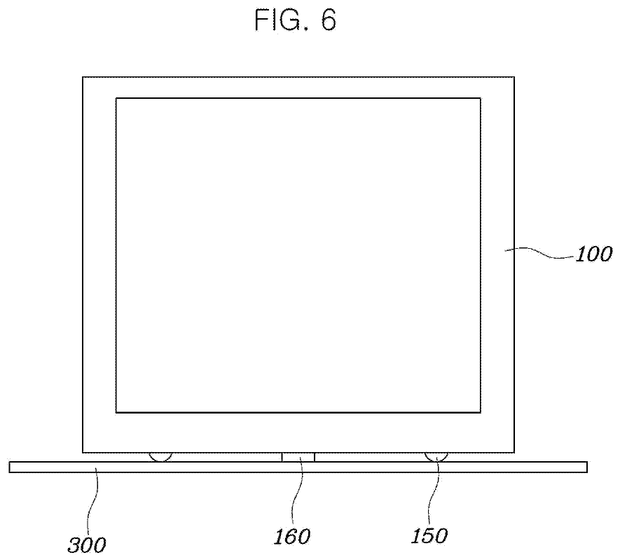

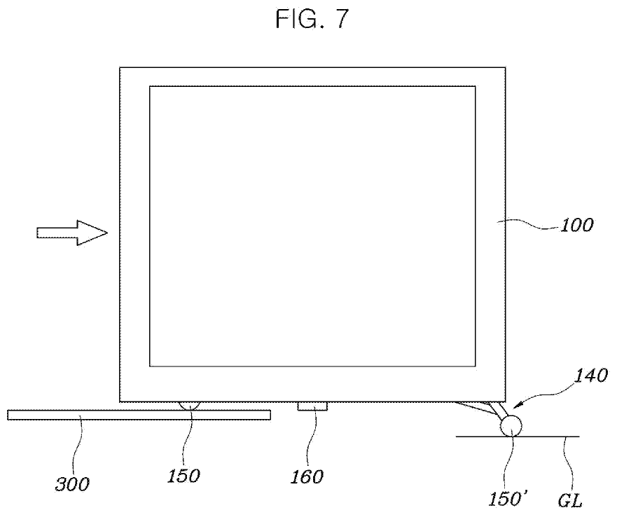

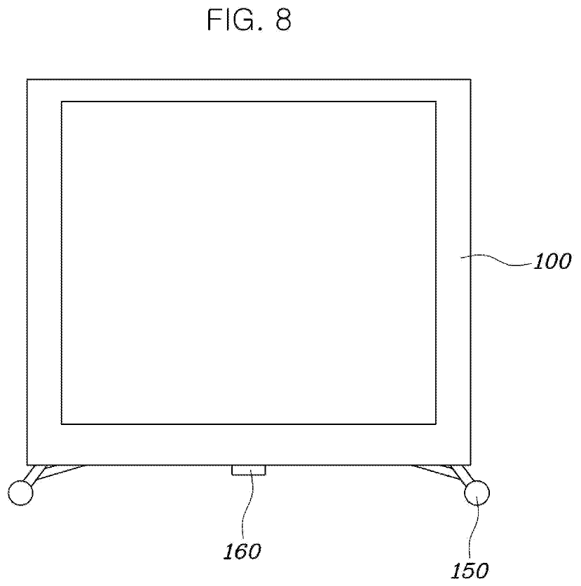

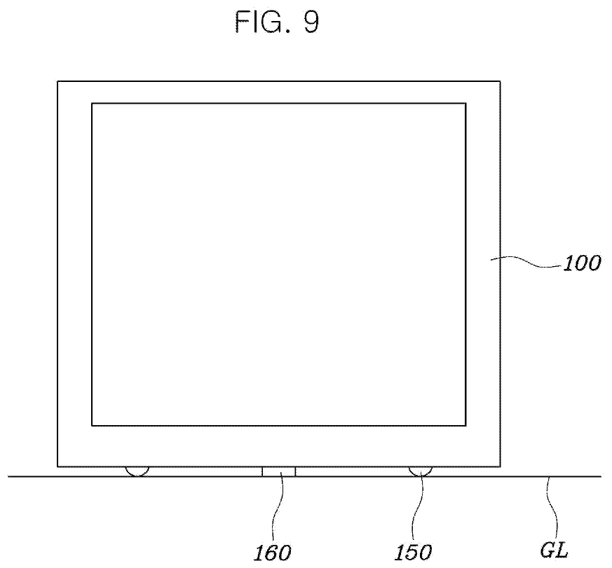

FIG. 1 is a view exemplarily illustrating a state in which a mobile frame for a vehicle according to an exemplary embodiment of the present disclosure is provided in a vehicle, FIG. 2 is a view exemplarily illustrating a state in which the mobile frame for a vehicle according to the exemplary embodiment of the present disclosure is provided outside the vehicle, FIG. 3 and FIG. 4 are views exemplarily illustrating a state in which a link assembly of the mobile frame for a vehicle according to the exemplary embodiment of the present disclosure is accommodated, FIG. 5 is a view exemplarily illustrating a state in which the link assembly of the mobile frame for a vehicle according to the exemplary embodiment of the present disclosure is deployed, FIG. 6 is a view exemplarily illustrating a state in which the mobile frame for a vehicle according to the exemplary embodiment of the present disclosure is provided on a floor of the vehicle, FIG. 7 is a view exemplarily illustrating a state in which the mobile frame for a vehicle according to the exemplary embodiment of the present disclosure is withdrawn from the vehicle, FIG. 8 is a view exemplarily illustrating a state in which the link assembly of the mobile frame for a vehicle according to the exemplary embodiment of the present disclosure is deployed outside the vehicle, and FIG. 9 is a view exemplarily illustrating a state in which the link assembly of the mobile frame for a vehicle according to the exemplary embodiment of the present disclosure is accommodated outside the vehicle.

A mobile frame for a vehicle according to an exemplary embodiment of the present disclosure includes: a main body configured so that a convenience device is mounted on or released from the main body, the main body being coupled to a rail formed on a floor of the vehicle, configured to be slidable on the rail, and configured to be withdrawn to the outside of the vehicle through a door opening portion of the vehicle; and moving wheels connected to a lower portion of the main body by link assemblies and configured to be accommodated in the lower portion of the main body, when the main body is coupled to the floor of the vehicle, and deployed downwardly from the main body when the main body is withdrawn to the outside of the vehicle.

First, an example to which the mobile frame for a vehicle of the present disclosure is applied will be described with reference to the drawings. FIG. 1 is a view exemplarily illustrating a state in which the mobile frame for a vehicle according to the exemplary embodiment of the present disclosure is provided in the vehicle, and FIG. 2 is a view exemplarily illustrating a state in which the mobile frame for a vehicle according to the exemplary embodiment of the present disclosure is provided outside the vehicle.

FIG. 1 illustrates that the mobile frame is provided inside the vehicle. In the instant case, as illustrated, a main body 100 of the mobile frame may be provided on a floor 300 of the vehicle. Furthermore, a display 520, as a convenience device, may be provided on the main body 100 so that occupants may watch videos of the display 520. The main body 100 may be provided on a rail 310 of the floor 300 of the vehicle and slide leftward and rightward. In the illustrated case, a door 340 is provided at a lateral side of a vehicle body, and the rail 310 provided on the floor 300 extends in left and right width directions of vehicle. Therefore, the main body 100 of the mobile frame may slide leftward and rightward on the floor 300 of the vehicle, i.e., slide in the width direction of the vehicle.

Furthermore, in case that the vehicle is stationary and the door 340 is opened, the mobile frame may be slid and withdrawn to the outside of the vehicle through an opening portion of the door 340.

FIG. 2 illustrates that the mobile frame is withdrawn to the outside of the vehicle. In case that the main body 100 is withdrawn to the outside of the vehicle, the main body 100 is used to install various convenience devices outside the vehicle. For example, as illustrated, a table 560 may be provided on the main body 100 outdoors so that the users may enjoy coffee or the like, and various shelves 540 may be provided on the main body so that a simple store may be operated outdoors.

As described above, the mobile frame of the present disclosure may be fixed in the vehicle and provided outside the vehicle. Various convenience devices may be provided on the mobile frame so that the mobile frame is configured as a frame with maximized utilization.

Furthermore, in case that the vehicle is an autonomous vehicle or an electric vehicle, the mobile frame of the present disclosure enables the vehicle to be utilized as a mobile cafe or store, and the user's utilization may also be diversified, which enriches human life.

Several functions are required to allow the mobile frame of the present disclosure to be used in both the inside and outside of the vehicle. The rigidity needs to be ensured in the vehicle to prevent an injury caused by the provided convenience device in the event of a collision of the vehicle. Therefore, the main body 100 needs to be made of a material, such as steel, to ensure the rigidity. Furthermore, the frame needs to be sized to fill the interior of the vehicle to ensure a size for mounting various convenience devices. Furthermore, because the weight is increased because of the material and size, the rail 310 needs to be provided in the vehicle to move the frame, and the frame needs to slide along the rail 310.

To the present end, the rail 310 is formed on the floor 300 of the vehicle. The rail 310 extends in the width direction of the vehicle and guides the sliding motion of the main body 100 in the width direction of the vehicle. Furthermore, the rail 310 extends toward the opening portion of the door 340 of the vehicle. Therefore, when the door 340 of the vehicle is opened, the main body 100 is guided so that the main body 100 slides to the outside of the vehicle along the rail 310.

Moving wheels 150 are connected to a lower portion of the main body 100 by link assemblies 140. In case that the main body 100 is coupled to the floor 300 of the vehicle, the moving wheel 150 is accommodated in the lower portion of the main body 100 and guides the sliding motion of the main body 100 on the rail 310. Because the main body 100 has difficulty in moving because of friction in a state in which the main body 100 is in surface-contact with the rail 310, the main body 100 may be easily slid by the moving wheel 150 provided on the lower portion of the main body 100 so that the position of the main body 100 may be changed. Furthermore, in case that the main body 100 is withdrawn to the outside of the vehicle, the moving wheel 150 is deployed downwardly from the main body 100 so that the horizontality of the main body 100 is maintained during the withdrawal process.

The floor 300 of the vehicle includes a difference in height from a ground surface GL. Therefore, a portion of the main body 100, which is exposed to the outside thereof, needs to be supported on the ground surface GL while the main body 100 is withdrawn to the outside of the vehicle. That is, to stably withdraw the main body 100, a portion of the main body 100, which is exposed, may be supported on the ground surface GL, and the remaining portion of the main body 100, which is not exposed, may be supported on the floor 300 of the vehicle so that the horizontality of the main body 100 may be maintained, and the frame may be stably withdrawn without an accident. To the present end, the moving wheel 150 is provided on the main body 100 by the link assembly 140. The link assembly 140 is folded and accommodated in the lower portion of the main body 100, and the link assembly 140 is unfolded and deployed toward the ground surface GL.

FIG. 3 and FIG. 4 are views exemplarily illustrating a state in which the link assembly of the mobile frame for a vehicle according to the exemplary embodiment of the present disclosure is accommodated, and FIG. 5 is a view exemplarily illustrating a state in which the link assembly of the mobile frame for a vehicle according to the exemplary embodiment of the present disclosure is deployed.

As illustrated, the main body 100 may include a quadrangular frame shape. Furthermore, the convenience device provided on the main body 100 may be at least one of a display, a storage box, a shelf, and a table.

Meanwhile, a connector 160 is provided at a lower end portion of the main body 100, and the convenience device may be electrically connected to the vehicle by the connector 160 and the rail 310. The connector 160 may be electrically connected to the convenience device provided on the main body 100. Furthermore, in case that the connector 160 may be electrically connected to a separate terminal provided on the rail 310, the connector 160 is connected to a battery of the vehicle through the terminal. Therefore, the convenience device provided on the main body 100 may be electrically connected to the vehicle and also enable data communication.

Meanwhile, the main body 100 may be supported on the rail 310 by the moving wheel 150. Furthermore, the rail 310 may extend in a direction from the floor 300 of the vehicle toward the door 340.

The rail 310 may include a groove 301 recessed in the floor 300 of the vehicle, and a catching portion 320 may be formed on an upper portion of the rail 310. A protruding portion 120 may be formed at the lower end portion of the main body 100, and the protruding portion 120 may be caught by the catching portion 320 without being withdrawn upward in a state in which the protruding portion 120 is inserted into the groove 301 of the rail. Therefore, the main body 100 may stably slide on the rail 310 by a rolling motion of the moving wheel 150. When the catching portion 320 and the protruding portion 120 are caught by each other, the main body 100 is prevented from swaying in the vehicle and being withdrawn from the floor 300. Therefore, even in the event of a collision of the vehicle or even when the vehicle travels on an uneven road surface, the position of the main body 100 may be stably maintained, and the safety and convenience of passengers are ensured.

In case that the main body 100 is coupled to the floor 300 of the vehicle, the link assembly 140 may be folded and accommodated in the lower portion of the main body 100, the lower end portion of the moving wheel 150 may be exposed downwardly from the main body 100 and supported on the rail 310.

FIG. 6 is a view exemplarily illustrating a state in which the mobile frame for a vehicle according to the exemplary embodiment of the present disclosure is provided on the floor of the vehicle, FIG. 7 is a view exemplarily illustrating a state in which the mobile frame for a vehicle according to the exemplary embodiment of the present disclosure is withdrawn from the vehicle, FIG. 8 is a view exemplarily illustrating a state in which the link assembly of the mobile frame for a vehicle according to the exemplary embodiment of the present disclosure is deployed outside the vehicle, and FIG. 9 is a view exemplarily illustrating a state in which the link assembly of the mobile frame for a vehicle according to the exemplary embodiment of the present disclosure is accommodated outside the vehicle.

The link assembly 140 includes a deployment portion configured to provide elasticity in a deployment direction thereof. In case that the main body 100 is withdrawn to the outside of the vehicle, the link assembly 140 may be deployed by the deployment portion so that the moving wheel may be supported on the ground surface outside the vehicle. As illustrated, an example of the deployment portion may include a cylinder 170 and a piston 174. Furthermore, the cylinder 170 is charged with hydraulic pressure or pneumatic pressure, and a component, such as a spring, is embedded in the cylinder 170 so that pressure may be always applied in a direction in which the piston 174 is extended.

FIG. 5 is a view exemplarily illustrating a lower surface of the main body. The moving wheel 150 and the link assembly 140 may be accommodated in the lower portion of the main body 100. FIG. 5 illustrates that the link assembly 140 is folded, and the piston 174 is compressed into the inside of the cylinder 170. The cylinder 170 is provided on the main body 100 by a rotation shaft 172, and a link 142 configured to support the moving wheel 150 is also connected to the main body by a rotation shaft 143. Furthermore, the piston 174 is connected to the link 142 by a support bar 144 so that the moving wheel 150 becomes closer to the lower surface of the main body 100 when the piston 174 is retracted, and the moving wheel 150 is deployed in a direction away from the main body 100 when the piston 174 is extended.

FIG. 6 illustrates that the main body is provided on the rail of the floor of the vehicle. In the instant case, the link assembly 140 is accommodated, and the main body 100 is slid on the rail 310 by the moving wheel 150 and coupled to the floor 300.

FIG. 7 illustrates that the door 340 of the vehicle is opened, and a portion of the main body 100 is withdrawn to the outside of the vehicle through the opening portion. The link assemblies 140 and the moving wheels 150 are provided at two opposite sides of the lower end portion of the main body. In case that the main body 100 is withdrawn from the vehicle, the link assembly 140, which is one of the link assemblies at the two opposite sides which is withdrawn first, may be deployed and supported on the ground surface GL by the moving wheel 150′, and in the instant state, the remaining portion of the main body 100 may be withdrawn. With the present configuration, the main body 100 stably has horizontality with respect to the ground surface GL or the floor 300 of the vehicle even in the state in which a portion of the main body 100 is withdrawn, which prevents breakdowns of the main body 100 and the convenience device provided on the main body 100. Furthermore, the main body 100 is stably supported so that the user, who withdraws the main body 100, may conveniently withdraw the main body 100 to the outside without being injured.

As illustrated in FIG. 8, both the link assemblies 140 are deployed in case that the main body 100 is stably withdrawn to the outside of the vehicle. Therefore, the main body 100 may move on the ground surface GL by the moving wheels 150 in a state in which the main body 100 includes a predetermined height from the ground surface GL.

Furthermore, in case that the main body 100 needs to be accommodated at a point on the ground surface GL, both the link assemblies 140 at the two opposite sides are contracted so that the main body 100 may be fixed to the ground surface GL, as illustrated in FIG. 9. Even in the instant case, a portion of the lower end portion of the moving wheel 150 is exposed to the ground surface so that the main body 100 may slide on the ground surface GL. A center of gravity of the main body 100 is lowered by the contraction of the link assembly 140 so that the main body 100 may be stably used outside the vehicle, as illustrated in FIG. 2.

The mobile frame for a vehicle of the present disclosure may be provided inside or outside the vehicle and provided with various convenience devices which may be freely used by the users inside or outside the vehicle.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A mobile frame for a vehicle, the mobile frame comprising:
a main body configured so that a convenience device is mounted on or released from the main body, the main body being slidably coupled to a rail formed on a floor of the vehicle and configured to be withdrawn to an outside of the vehicle through an opening portion of a door of the vehicle; and
moving wheels connected to a lower portion of the main body by link assemblies and configured to be accommodated in the rail of the main body in response that the main body is coupled to the floor of the vehicle, and deployed downwardly from the main body in response that the main body is withdrawn to the outside of the vehicle.

2. The mobile frame of claim 1, wherein the main body has a quadrangular frame shape.

3. The mobile frame of claim 1, wherein the convenience device includes at least one of a display, a storage box, a shelf, and a table.

4. The mobile frame of claim 1, wherein a connector is provided at a lower end portion of the main body, and the convenience device is electrically connected to the vehicle through the connector and the rail.

5. The mobile frame of claim 1, wherein the main body is supported on the rail by the moving wheels.

6. The mobile frame of claim 1, wherein the rail extends in a direction from the floor of the vehicle toward the opening portion of the door.

7. The mobile frame of claim 1, wherein the rail includes a groove recessed in the floor of the vehicle, a catching portion is formed on an upper portion of the rail, and a protruding portion is formed at the lower portion of the main body and caught by the catching portion not to be withdrawn upward in a state in which the protruding portion is inserted into the groove of the rail.

8. The mobile frame of claim 1, wherein in response that the main body is coupled to the floor of the vehicle, each link assembly is folded and accommodated in the lower portion of the main body, and a lower end portion of the moving wheels are exposed downwardly from the main body and supported on the rail.

9. The mobile frame of claim 1, wherein each link assembly includes a deployment portion configured to provide elasticity in a deployment direction of the moving wheels, and
wherein in response that the main body is withdrawn to the outside of the vehicle, each link assembly is deployed by the deployment portion, and the moving wheels are supported on a ground surface outside the vehicle.

10. The mobile frame of claim 9,
wherein the deployment portion of each link assembly includes a cylinder and a piston slidably coupled to the cylinder, an end of the cylinder being pivotally connected to the moving frame, and
wherein each link assembly further includes:
a link; and
a support bar connecting an end of the piston and the link,
wherein a first end of the link is pivotally connected to the main body, and a second end of the link is rotatably connected to a corresponding moving wheel of the moving wheels.

11. The mobile frame of claim 1,
wherein the link assemblies include first and second link assemblies,
wherein the moving wheels include first and second moving wheels,
wherein the first and second link assemblies and the first and second moving wheels are provided at first and second opposite sides of the lower portion of the main body, and
wherein in response that the main body is withdrawn from the vehicle, the first link assembly withdrawn first, is deployed and supported on a ground surface by the first moving wheel, and then a remaining portion of the main body is withdrawn.

12. The mobile frame of claim 1,
wherein the link assemblies include first and second link assemblies,
wherein the moving wheels include first and second moving wheels,
wherein the first and second link assemblies and the first and second moving wheels are provided at first and second opposite sides of the lower portion of the main body, and
wherein in response that the main body is withdrawn from the vehicle, the first link assembly is deployed and supported on a ground surface by the first moving wheel, and the second link assembly is deployed and supported on the ground surface by the second moving wheel, in sequence.

13. A vehicle comprising:
a floor including a rail; and
a mobile frame including:
a main body configured so that a convenience device is mounted on or released from the main body, the main body being slidably coupled to the rail formed on the floor of the vehicle, and configured to be withdrawn to an outside of the vehicle through an opening portion of a door of the vehicle; and
moving wheels connected to a lower portion of the main body by link assemblies and configured to be accommodated in the rail of the main body in response that the main body is coupled to the floor of the vehicle, and deployed downwardly from the main body in response that the main body is withdrawn to the outside of the vehicle.

14. The vehicle of claim 13, wherein the rail is formed on the floor of the vehicle in a width direction of the vehicle and reaches to the opening portion of the door.

15. The vehicle of claim 13, wherein a connector is provided at a lower end portion of the main body, and the convenience device is electrically connected to the vehicle through the connector and the rail.

16. The vehicle of claim 13, wherein the rail includes a groove recessed in the floor of the vehicle, a catching portion is formed on an upper portion of the rail, and a protruding portion is formed at the lower portion of the main body and caught by the catching portion not to be withdrawn upward in a state in which the protruding portion is inserted into the groove of the rail.

17. The vehicle of claim 13, wherein in response that the main body is coupled to the floor of the vehicle, the link assembly is folded and accommodated in the lower portion of the main body, and a lower end portion of the moving wheels are exposed downwardly from the main body and supported on the rail.

18. The vehicle of claim 13, wherein each link assembly includes a deployment portion configured to provide elasticity in a deployment direction of the moving wheels, and
wherein in response that the main body is withdrawn to the outside of the vehicle, each link assembly is deployed by the deployment portion in sequence, and the moving wheels are supported on a ground surface outside the vehicle.

19. The vehicle of claim 18,
wherein the deployment portion of each link assembly includes a cylinder and a piston slidably coupled to the cylinder, an end of the cylinder being pivotally connected to the moving frame, and
wherein each link assembly further includes:
a link; and
a support bar connecting an end of the piston and the link,
wherein a first end of the link is pivotally connected to the main body, and a second end of the link is rotatably connected to a corresponding moving wheel of the moving wheels.
